(19) United States
(12) Patent Application Publication
(10) Pub. No.: US 2012/0167375 A1
(43) Pub. Date: Jul. 5, 2012

(54) Long Length Electro Coiled Tubing and Method of Manufacturing Same

(75) Inventors: Sergio Pesek, Owasso, OK (US); David Neuroth, Clayton, NY (US); Don Cox, Roanoke, TX (US); Tim Pinkston, Chelsea, OK (US)

(73) Assignee: Baker Hughes Incorporated, Houston, TX (US)

(21) Appl. No.: 13/416,828

(22) Filed: Mar. 9, 2012

Related U.S. Application Data
(62) Division of application No. 12/491,091, filed on Jun. 24, 2009, now abandoned.

(51) Int. Cl. H01B 13/26

(52) U.S. Cl. 29/525.14

(57) ABSTRACT

Electro coiled tubing (ECT) can be utilized to provide electrical power to equipment in wells. A long length of ECT is provided with protrusions welded on the inside of the tubing at selected intervals to form support shoulders. Anchors with a load shoulder are attached to the electrical cable enclosed in the tubing such that the load shoulder contacts the support shoulder created by the welded protrusion. The weight of the electrical cable can then be transferred to the tubing via the contact between the load shoulder and the support shoulder. The protrusions are welded to the tubing and the anchors are attached to the cable during the manufacturing process.

### FIELD OF THE INVENTION

This invention relates in general to electro coiled tubing and in particular to the installation and manufacturing of electro coiled tubing to provide electrical power to equipment in wells.

### BACKGROUND OF THE INVENTION

Electro coiled tubing (ECT) may be utilized to provide electrical power to submersible pump equipment in wells. ECT cable is typically fabricated by laying a length of coiled tubing along a road or other surface, then pulling into the tubing an electrical cable with anchors already in place. The anchors are clamped around the electrical cables. The location of the anchors is then obtained by using electromagnetic eddy current detectors or by, an x-ray machine, or other suitable method. A dimple can then be formed on the coiled tubing below each anchor to provide a support shoulder on the interior of the coiled tubing. The dimples on the exterior of the coiled tubing are filled with weld material and the finished ECT cable is spooled up. The combination of the anchors on the electrical cable and the support shoulder on the coiled tubing allows the weight of the electrical cable to be transferred to the coiled tubing. Without this transfer of weight, the electrical cable would pull apart under its own weight.

This is a labor intensive and expensive process. In addition, the length of cable that can be pulled into the tubing is limited to approximately 8000 feet due to the increased frictional drag force that can exceed the strength of the cable.

A need exists for a technique that addresses the limitations and shortcomings described above. In particular a need exists for a technique to allow for ECT cable to be manufactured in a less labor intensive manner and in a manner that does not limit the continuous length of the ECT cable that can be manufactured. The following technique solves these problems.

### SUMMARY OF THE INVENTION

In an embodiment of the present technique, a long length of ECT cable, used to provide electrical power to equipment in wells, is provided with protrusions welded on the inside of the tubing at selected intervals to form support shoulders. Anchors with a load shoulder are attached to the electrical cable enclosed in the tubing such that the load shoulder contacts the support shoulder created by the welded protrusion. When the ECT cable is installed in the well, the weight of the electrical cable can be transferred to the tubing via the contact between the load shoulder and the support shoulder.

During the manufacturing process, the protrusions are welded to a sheet of steel and the anchors are attached to the electrical cable such that the protrusions align with the anchors. As the sheet of steel is rolled into tubing by formers, the protrusions, the anchors, and the electrical cable are enclosed within the formed tubing. A longitudinal weld seam will close the tubing and the finished ECT will be spooled onto a reel.

The welding of the protrusions during the manufacturing process allows for a relatively less labor intensive and less expensive assembly process because the support shoulders formed by the welded protrusions are aligned with the anchors on the electrical cable as the coiled tubing is being formed. In the past, the location of the anchors had to first be determined, for example, by an electromagnetic eddy current detector before the support shoulder could be formed by first dimpling the coiled tubing and then filling the dimple on the exterior of the tubing with weld material. Further, fabrication of the ECT cable in this manner does not limit the continuous length of ECT because the electrical cable does not have to be pulled into the coiled tubing.

In the illustrated embodiment, a welder deposits weld material onto a sheet of steel to form a protrusion. The sheet can be placed on a former having rollers that are in contact with the longitudinal edges of the sheet. An anchor can be clamped to an electrical cable taken from a spool. The anchor is clamped such that the protrusion on the sheet of metal aligns below and in contact with a load shoulder on the anchor as the cable is placed in proximity to the sheet. The load shoulder can be at one end of the anchor or at a central portion of the anchor which has an annular recessed area to accept the load shoulder.

The protrusions, the anchors, and the electrical cable become enclosed as the rollers of the former form the sheet of metal into tubing. As the tube is formed, a longitudinal weld seam is formed on the tubing. The finished ECT cable can then be spooled onto a reel and pressure tested. In addition, magnetic flux equipment can be used to check for discontinuities in the welded portions of the ECT cable.

During installation of the ECT cable, the load shoulder on the anchor will contact the support shoulder formed by the welded protrusion. The weight of the electrical cable will thereby be transferred through the load shoulder and support shoulder to the coiled tubing.

### BRIEF DESCRIPTION OF THE DRAWINGS

FIG. 1 shows an ECT cable section, in accordance with the invention.

FIG. 2 shows an ECT cable section showing an anchor clamped around an electrical cable, in accordance with the invention.

FIG. 3 shows an ECT cable section showing the interference between the welded protrusions on the interior of the coiled tubing and the anchor, in accordance with the invention.

FIG. 4 shows manufacturing process of the ECT cable, in accordance with the invention.

FIG. 5 shows an ECT cable section showing a load shoulder on the central portion of an anchor attached to an electrical cable, in accordance with the invention.

### DETAILED DESCRIPTION OF THE INVENTION

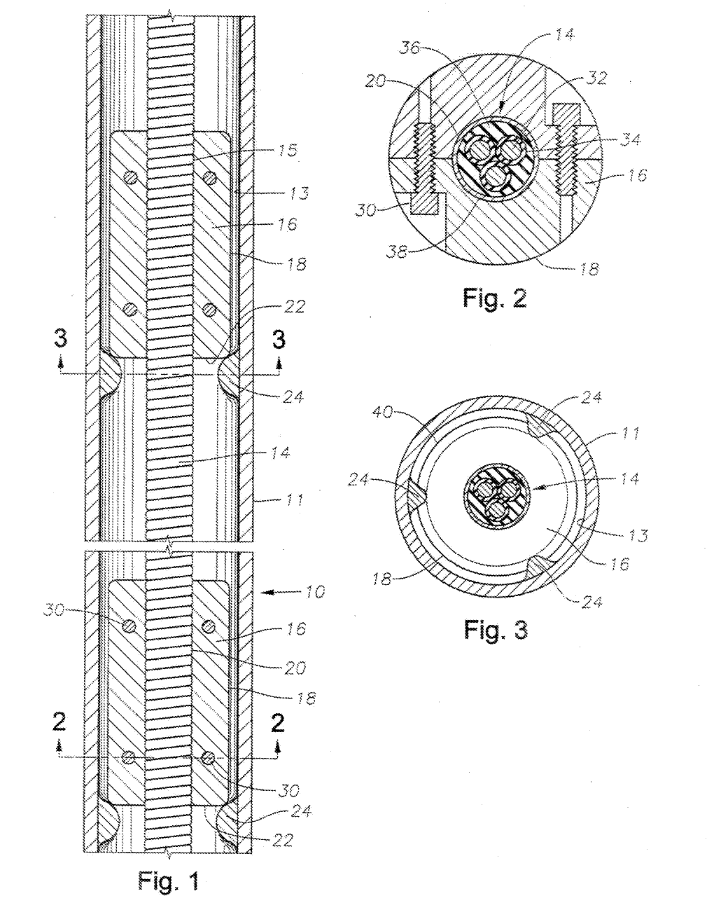

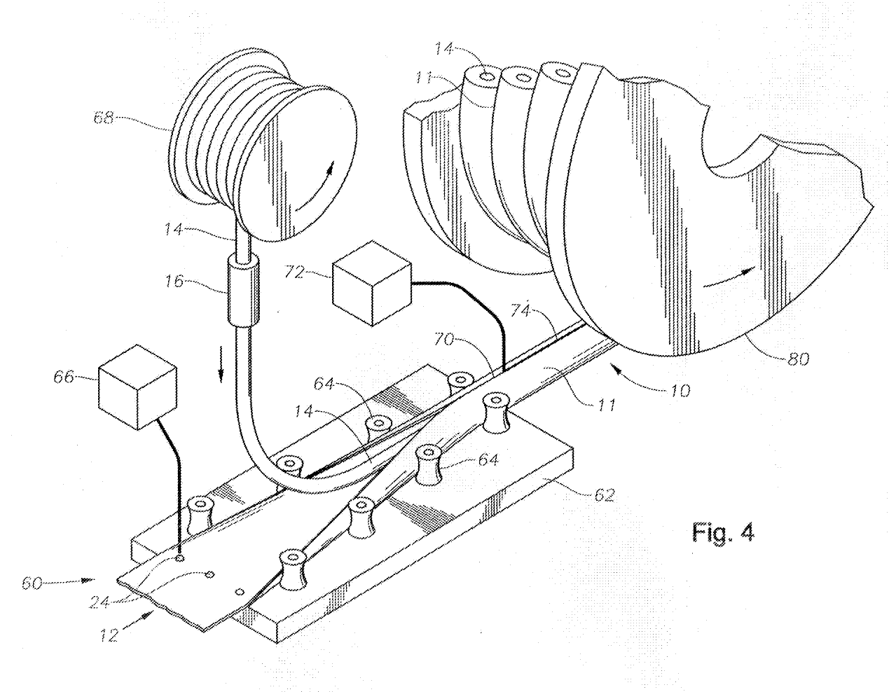

Referring to FIG. 1, an embodiment of the ECT cable 10 is illustrated. A length of coiled tubing 11 with a tubing inner diameter 13 and having an interior passage encloses an electrical cable 14 having a cable outer diameter 15. An anchor 16 with an anchor outer diameter 18 and an anchor inner diameter 20 is attached to the electrical cable 14 such that a load shoulder 22 on the lower end of the anchor 16 is in contact with at least one protrusion 24 welded onto the inside of the coiled tubing 11 that protrudes into the interior passage of the tubing 11. The protrusion 24 forms a support shoulder to transfer the weight of the electrical cable 14 to the tubing 11. In the example of FIG. 3, three protrusions 24 are attached to the tubing inner diameter 13 of the cable, each 120 degrees apart from the other. Each protrusion 24 has an axis, and the axes of protrusions 24 are located in a plane perpendicular to the axis of coiled tubing 11. The coiled tubing 11 can be formed from a sheet of steel 12 (FIG. 4) and the anchor 16 and protrusions 24 can occur at selected longitudinal intervals of the ECT cable 10.

FIG. 2 shows a section of the ECT cable 10. The anchor 16 can be comprised of two semi-cylindrical steel halves clamped around the electrical cable 14 with threaded fasteners 30. The electrical cable 14 can have electrical conductors 32 surrounded by insulation 34 and embedded within an elastomeric jacket 36. A metal armor 38 can be wrapped around the exterior of the elastomeric jacket 36. FIG. 3 also shows a section of the ECT cable 10 and shows the interference between the anchor 16 and welded protrusions 24. Other types of anchors, other than steel halves, could be employed, such as coiled wire with bristles, as in U.S. Pat. No. 6,167,915, elastomeric clamp members as in U.S. Pat. No. 5,821,452, coiled wire as in U.S. Pat. No. 6,479,752, or helical strips. Also, it is not necessary that anchor 16 has a load shoulder 22 as long as a portion of anchor 17 engages protrusion 24 to transmit the weight of cable 10 to coiled tubing 11.

An illustration of the fabrication process of ECT cable 10 is shown in FIG. 4. A former or tubing fabrication machine 60 with a base 62 and rollers 64 can receive a sheet of metal 12. As the sheet of metal 12 is moved through the former 60, a protrusion 24 is welded onto the surface of the sheet 12 by a welder 66 and the sheet 12 is incrementally deformed by each set of rollers 64. The rollers 64 are spaced progressively closer together to ultimately deform the sheet into cylindrical tubing 11 as it is pulled through the former 60.

As the electrical cable 14 is taken from a spool 68 and fed into the tubing 11 as it is formed, an anchor 16 having a load shoulder 22 is attached to the cable 14. Alternatively, the anchors can be placed on the cable at predetermined spacing prior to the tube forming operation. The anchor 16 can be clamped to the electrical cable 14 and is located on the cable 14 such that a load shoulder 22 (FIG. 1) at an end of the anchor 16 will be in contact with an upward facing surface of the welded protrusion 24 in the finished ECT cable 10. This feature will allow the weight of the cable 14 to transfer to the coiled tubing 11 when the ECT cable 10 is installed within a well. Further, the anchor 16 and protrusions 24 can be installed and welded, respectively, at selected intervals in the process. Rather than forming protrusions 24 by applying weld material to the tubing inner diameter 13, they could be preformed members that are attached to the tubing inner diameter such as by welding, bonding or with a fastener.

As the sheet 12 is formed into tubing 11, the electrical cable 14 along with the anchor 16 is enclosed within the tubing 11. A longitudinal weld 74 can then be welded onto inside surface of the metal sheet by a seam welder 72 and the finished ECT cable 10 can then be coiled onto a reel 80. The ECT cable 10 can then be pressure tested on the reel 80.

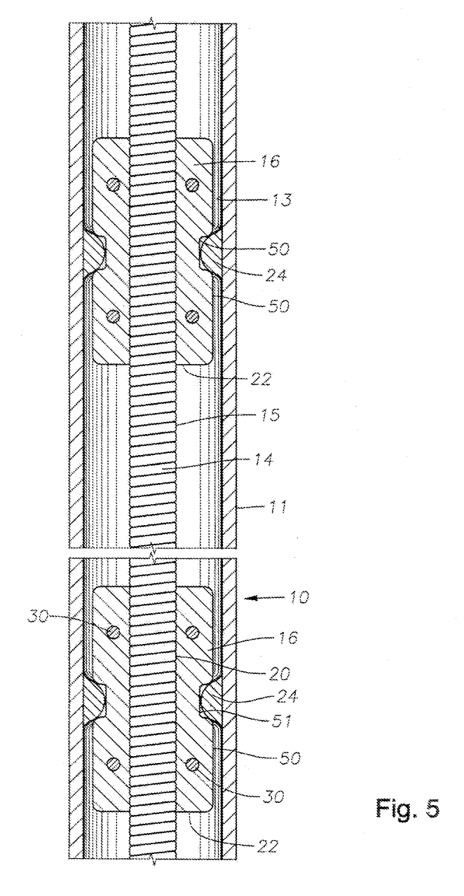

In another embodiment illustrated in FIG. 5, a different anchor can be utilized. The anchor 50 shown has a load shoulder formed by an annular recess 51 located at a central portion of the anchor 50. The downward facing surface of the annular recess 51 acts as a load shoulder and is in contact with an upward facing surface of the welded protrusion 24 when the ECT cable 10 is installed in the well. This embodiment can support the cable 14 in either direction in the event the tubing is reversed before installing it in the well.

In a further embodiment, weld material can form the protrusion 24 that extends inward into the passage of the tubing 11. A welder can deposit sufficient weld material onto the surface of the sheet of steel 12 that forms the tubing 11 to provide a support shoulder for the load shoulder of the anchor 16.

In a further embodiment, a set of protrusions 24 can be welded in the tubing adjacent to the load shoulder of the anchor 24. The protrusions can be disposed circumferentially around the tubing. Protrusions 24 can also be fabricated by spot welding pieces of steel to the inside of the metal sheet.

In yet another embodiment, a set of protrusions can be welded onto the anchor 24 to form a load shoulder. These protrusions are in addition to the protrusions 24 welded onto the tubing and are preferably welded onto either end of the anchor 24.

Feeding the cable 14 and anchors 16 and welding the protrusions 24 onto the tubing 11 as the tubing 11 is formed reduces labor intensiveness and expense by eliminating the need for locating the anchors via electromagnetic eddy current equipment and then crimping the tubing to provide the support shoulder. Further, the length of the finished ECT cable 10 is not limited by length of the cable 14 that can be pulled because it is fed, along with the anchors 16, into the tubing 11 as it is formed. In the example shown in the figures, the finished ECT cable 10 is only limited in length by the spool 68 and reel 80 capacities.

This written description uses examples to disclose the invention, including the best mode, and also to enable any person skilled in the art to practice the invention, including making and using any devices or systems and performing any incorporated methods. These embodiments are not intended to limit the scope of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-12. (canceled)

13. A method of installing electrical cable within coiled tubing for use in a well, the electrical cable having at least one insulated electrical conductor embedded within an elastomeric jacket, comprising:
(a) pulling a sheet of steel through a former to bend the sheet into cylindrical tubing;
(b) securing at least one protrusion on the interior side of the sheet of steel being formed into tubing;
(c) attaching at least one anchor onto the exterior of the electrical cable;
(d) feeding the cable into the tubing as it is being formed, the protrusion protruding into an interior passage of the tubing to form at least one load supporting surface for supporting the anchor when the tubing is installed within the well; and
(e) welding a longitudinal seam of the tubing.

14. The method of claim 13, wherein step (c) comprises clamping the anchor onto the electrical cable.

15. The method of claim 13, wherein step (b) comprises depositing weld material onto the sheet of metal to form the protrusion.

16. The method of claim 13, wherein step (b) comprises welding a preformed member onto the sheet of metal to form the protrusion.

17. The method of claim 13, wherein step (e) further comprises coiling the tubing onto a reel.

18. The method of claim 13, wherein step (c) further comprises the step of aligning an upward facing surface of the protrusion with a downward facing surface of the anchor.

19. The method of claim 13, further comprising repeating steps (b) and (c) at selected intervals.

20. The method of claim 13, further comprising enclosing the electric cable in an armor of a metal wrap.
